(19) United States
(12) Patent Application Publication
(10) Pub. No.: US 2019/0323483 A1
(43) Pub. Date: Oct. 24, 2019

(54) Device and Method for Calibrating a Wind Vane of a Wind Turbine

(71) Applicant: Suzlon Energy Limited, Ahmedabad (IN)

(72) Inventor: Max Mesenholl, Rostock (DE)

(21) Appl. No.: 16/169,262

(22) Filed: Oct. 24, 2018

(30) Foreign Application Priority Data
Oct. 27, 2017 (IN) 201721038310

(51) Int. Cl. F03D 17/00; G01P 13/02; G01N 21/84; G01C 15/00

(52) U.S. Cl. CPC F03D 17/00; G01P 13/02; F03D 1/00; G01C 15/004; G01N 21/84

(57) ABSTRACT

A device is provided for calibrating a wind vane in relation to an orientation of a rotor of a wind turbine. The calibration device includes an attachment device with a first attachment member, which is adapted for receiving the wind vane, a second attachment member, which is adapted for mounting the calibration device to the wind turbine, a first calibration mark, which is mounted to or provided at the attachment device, said first calibration mark representing or corresponding to a predefined orientation of the wind vane, and a laser device, which is mounted to the attachment device or which is adapted to interact with the attachment device, such that a laser beam being generated by said laser device hits the first calibration mark.

### CROSS-REFERENCE TO RELATED APPLICATION

This application claims priority to Indian Patent Application No. 201721038310 filed Oct. 27, 2017, the disclosure of which is hereby incorporated in its entirety by reference.

### FIELD OF THE INVENTION

The present invention relates to a device and method for calibrating a wind vane of a wind turbine and to a wind turbine. The present invention is also directed to the technical field of wind turbines, in particular to wind turbines of the horizontal type, which means that the wind turbines include a horizontal axis and a rotor being directed against the wind.

### BACKGROUND

Such wind turbines generally include a nacelle incorporating a drive train. The nacelle is mounted to a tower. A rotor with one or more rotor blades, particularly with three rotor blades, is connected to the drive train via a hub, to which the rotor blades are mounted. The rotor rotates around its rotational axis. In particular, the rotational axis of the rotor corresponds to the central axis of the drive train being located within the nacelle. In particular the rotor axis of the rotor is aligned to the central axis of the drive train.

In order to improve the generation of electrical power by the wind turbine it is a need to bring the rotor into an advantageous orientation with regard to the wind direction. For this purpose, it is known to use a wind vane, said wind vane indicating the direction of the wind. Typically, the wind vane is mounted to the roof of the nacelle. In order to minimize the impact of the rotor on the wind vane, the wind vane is mounted as far away as possible from the rotor in the rear portion of the nacelle.

The wind direction measured by the wind vane is generally used to adjust the orientation of the rotor in relation to the wind direction. Such an adjustment by use of a wind vane is generally known in prior art, since a non-accurate alignment of the wind vane in relation to the orientation of the rotor may lead to energy losses as well as to additional structural loads. Therefore, it is necessary to calibrate the wind vane in relation to the orientation of the rotor of the wind turbine. One solution with this regard is disclosed in document U.S. Pat. No. 9,395,231 B2, which describes a system and a method for calibrating a wind vane of a wind turbine. According to this known solution the position and the orientation of the rotational axis of the rotor is transmitted from the inside of the nacelle to the outside of the nacelle by means of a calibrating device which is mounted on the main shaft relative to an orientation of the main shaft inside the nacelle and which projects from the interior of the nacelle to an exterior of the nacelle through an opening in the roof of the nacelle. The axial alignment of the wind vane is performed outside the nacelle on its roof.

However, this known solution shows a number of drawbacks. First of all, it is necessary to carry the calibrating device, which is quite massive, to the nacelle by means of the service elevator. Furthermore, the calibration process has to be performed outside the nacelle on its roof which is a zone of increased danger of falling. Therefore, it is desirable to minimize the stay of service people in this area. The alignment of the wind vane can be performed by means of a visual bearing. However, in such a case the service people must be situated behind the wind vane, which is, for aerodynamically reasons, usually mounted to the nacelle as far away as possible from the rotor. For a service person, this area in the rear part of the nacelle is very difficult to reach.

### OBJECT OF THE INVENTION

Starting from the above mentioned state of the art, it is the object of the present invention to avoid the aforementioned drawbacks.

In particular, it is the object of the present invention to provide a calibration device which has a simple construction and which allows a riskless calibration of the wind vane, in particular inside the nacelle.

Another object of the present invention is minimize the requirement of massive calibrating device to the nacelle through service elevator thereby reducing the chances of falling of the service engineer.

### SUMMARY OF THE INVENTION

According to the invention, the object is solved by the calibration device with the features according to the present disclosure, and by the method of calibrating a wind vane with the features of the present disclosure. Therein, features and details which are described in connection with one aspect according to the invention apply with respect to their disclosure in their entirety also to the other aspects according to the invention, so that statements made with respect to one aspect of the invention also apply to their full extent to the other aspects of the invention and vice versa.

The underlying concept of the present invention is that the calibration of the wind vane is transferred from the outside of the nacelle to the interior of the nacelle. In particular, the present invention provides a solution for calibrating a wind vane inside the nacelle of a wind turbine. A predefined orientation of the wind vane, in particular the 0° position of the wind vane, is lead or guided from the outside of the nacelle, via the calibration device, to the interior of the nacelle. By use of a laser device which is part of the calibration device, and by means of the advantageous alignment of the laser beam being generated by said laser device, an angle deviation of the wind vane in relation to the orientation of the rotor can be determined such that appropriate measures can be taken.

According to the first aspect of the present invention, a device for calibrating a wind vane in relation to the orientation of a rotor of a wind turbine is provided, said calibration device being characterized by an attachment device with a first attachment member, which is adapted for receiving a wind vane, and with a second attachment member, which is adapted for mounting the calibration device to the wind turbine, in particular to a nacelle of the wind turbine, a first calibration mark, which is mounted to or provided at the attachment device, said first calibration mark representing or corresponding to a predefined orientation of the wind vane, in particular the 0° position of the wind vane, and a laser device, which is mounted to the attachment device or which is adapted to interact with the attachment device, such that a laser beam being generated by said lased device hits the first calibration mark.

According to this first aspect the present invention is directed to a device for calibrating a wind vane in relation to the orientation of a rotor of a wind turbine.

In particular, a wind vane is an instrument for showing or detecting the direction of the wind. Therefore, the wind fane can be defined as some kind of a wind sensor element.

In particular, the calibration device is provided to precisely adjusting the wind vane of the wind turbine for a particular function, which is in particular bringing the rotor of the wind turbine into an advantageous orientation with regard to the wind direction, in order to improve the generation of electrical power by the wind turbine.

According to a preferred embodiment the calibration device is provided for adjusting the wind vane in parallel to the orientation of the rotor.

In particular, the calibration device is provided for adjusting the wind vane in parallel to a reference axis or to a reference plane of the drive shaft. Preferably the reference axis is the central axis of the drive train, whilst the reference plane is the vertical mid-plane of the drive train. Preferably, the reference axis or the reference plain of the drive shaft correspond to the rotational axis of the rotor, said drive train being located inside the nacelle of the wind turbine. In particular, the rotor of the wind turbine is pivotally mounted around a rotational axis to the drive train, preferably via a hub, whereby the rotational axis of the rotor preferably corresponds to the reference axis or to a reference plane of the drive train. In particular the reference axis or the reference plane of the drive train is arranged in extension of the rotational axis of the rotor. Preferably the rotational axis of the rotor is aligned to the reference axis or the reference plane of the drive train. The aforementioned definitions and coherences apply to all aspects of the present invention.

Furthermore, the calibration device includes an attachment device which is provided for mounting the wind vane to the wind turbine, in particular to the nacelle.

According to a preferred embodiment, the attachment device is provided for mounting the wind vane, which is located outside of the nacelle, to the nacelle, in particular to the drive train being mounted therein, or outside the nacelle on its roof or inside the nacelle beneath its roof. In a preferred embodiment, the wind vane is mounted to the inside or interior of the nacelle.

The attachment device includes a first attachment member, which is adapted for receiving a wind vane. Therefore, the wind vane is mounted to the first attachment member, preferably via a first attachment flange. In particular the first attachment member is provided by a first portion of the attachment device, to which the wind vane is mounted.

Furthermore, the attachment device includes a second attachment member, which is adapted for mounting the calibration device to the wind turbine, in particular to the inside of a nacelle of the wind turbine. Therefore, the calibration device is mounted through the second attachment member to the wind turbine, in particular to the nacelle, more particularly to the inside of the nacelle, preferably via a second attachment flange. In particular the second attachment member is provided by a second portion of the attachment device, by means of which the calibration device is mounted to the nacelle. Preferably the attachment device is mounted through its second attachment member to the roof of the nacelle outside the nacelle, or to the roof of the nacelle inside the nacelle, or to a component of the drive train being located inside the nacelle, or to a heat exchanger device for example, or the like. The present invention is not limited to specific locations or components to which the calibration device is mounted via its attachment device.

According to a preferred embodiment, one portion of the attachment device, which includes or is the first attachment member, and which receives the wind vane, is located outside the nacelle, whilst another portion of the attachment device, which includes or is the second attachment member, is located or lead or guided inside the nacelle, in particular through an opening in the roof of the nacelle. This latter portion of the attachment device is preferably mounted as described further above.

The present invention is not delimited to specific types or configurations of the attachment device and of the first and second attachment members. Some advantageous embodiments thereof are described in more detail further below.

Another component of the calibration device according to the first aspect of the invention is a first calibration mark, which is mounted to or provided at the attachment device. In particular, a calibration mark is a feature or member that gives information in order to performing the calibration of the wind vane as mentioned in more detail further above. In particular the first calibration mark is mounted to or provided at the outer surface of the attachment device.

According to the present invention the first calibration mark represents or corresponds to a predefined orientation of the wind vane, in particular the 0° position of the wind vane, the North position of the wind vane or the South position of the wind vane. However, any predetermined orientation of the wind vane may serve being the predefined orientation thereof. According to a preferred embodiment which is described in connection with the wind vane further below, the predefined orientation of the wind vane is adjusted in relation to the first calibration mark. The present invention is not delimited to specific types or configurations of the first calibration mark. Some advantageous embodiments thereof are described in more detail further below.

Furthermore, according to the present invention, the calibration device includes a laser device, which is mounted to the attachment device or which is adapted to interact with the attachment device. The laser device is provided for generating a laser beam. The laser device includes a laser source and optical elements, said optical elements being adapted for bringing the laser irradiation, which has been generated by the laser source, into a desired shape. Therefore, the optical elements generate a desired beam pattern of laser light.

The laser device is mounted to the attachment device or is adapted to interact with the attachment device in such a way that the laser beam being generated by said lased device hits the first calibration mark.

According to a preferred embodiment the generated laser beam is aligned with the first calibration mark. That means that the laser beam generated by said laser device preferably provides an elongation or alignment of the first calibration mark. Since the first calibration mark represents or corresponds to the predefined position of the wind vane, the laser beam hitting the first calibration mark represents or corresponds to the predefined position of the wind vane, in particular to the 0° position, as well.

According to a preferred embodiment, the laser device is mounted to the attachment device at a position, which is located inside the nacelle, when the calibration device has been mounted to the nacelle. Same applies with the first calibration mark. In this case the laser beam generated by said laser device hits the first calibration mark inside the nacelle. Therefore, the predefined position of the wind vane gets transferred into the interior of the nacelle. For this purpose, the laser device is mounted to the attachment device in such a way that the laser beam meets the first calibration mark. The laser beam now displays the predefined position of the wind vane, in particular its 0° position. How this can be achieved will be explained in more detail further below.

Since the laser device is used inside the nacelle, the laser device can also be used in situations with high solar radiation.

According to the preferred embodiment as described further above the wind vane can be paralleled to the orientation of the rotor by means of this laser device.

The present invention is not delimited to specific types of laser devices. Preferred embodiments are now described in more detail in order to explain the functionality and the character of the present invention.

Preferably, the laser device is a line laser device, in particular a cross-line laser device. Line laser devices per se are known in the state of the art. In general, a line laser device is a laser device with a specific optics generating a laser line instead of a laser point. A liner laser device includes a laser source, a punctual laser source for example. By means of optical elements, the laser beam generated by said laser source is broadened to a laser line. Besides simple laser lines, more complex line patterns can be generated as well, crossing lines for example.

According to a preferred embodiment, the line laser device includes a laser source, said laser source generating a laser beam. The line laser device is adapted such that the laser beam generated by said laser source is fanned-out to a laser line, whereby the fanned-out laser beam spans an angle.

According to this preferred embodiment the generated laser beam is broadened by fanning-out or by expanding the generated laser beam to a laser line. The generated laser beam spans an angle which particularly means that the fanned-out laser beam spreads out in a plane. This plane preferably corresponds to a specific beam pattern of the generated laser light. In particular, this plane or beam pattern can have a triangular or almost triangular shape. If the laser beam which is generated by the laser source and which is fanned-out to a laser line spreads out in such a triangular shaped plane or beam pattern, the laser source and the optical elements for fanning-out the laser beam can be located in the top of the triangle. One side of the triangle being opposite to the top of the triangle represents the laser line generated by said laser source. Both sides of the triangle connecting the top of the triangle with the side of the triangle representing the generated laser line are limiting sides of the triangle. These limiting sides border the plane or beam pattern of fanned-out laser light generated by said laser source, said laser plane ending in the laser line. If the laser device is provided in such a way it is preferably one of the limitation sides of the generated fanned-out triangular laser light plane which hits the first calibration mark of the calibration device. Due to the spanned angle, the second limitation side is directed away from the attachment device, in particular away from the first calibration mark. According to a preferred embodiment, which is explained in more detail further below, the second limitation side is directed into the interior of the nacelle of the wind turbine.

Preferably the calibration device is mounted via its attachment device to the nacelle, preferably to the inside of the nacelle, such that the generated laser beam is free from any obstructions caused by any components of the wind turbine being mounted inside the nacelle.

According to a preferred embodiment the attachment device is provided as an elongated member, in particular as an elongated attachment profile element or as an elongated attachment tube or as an elongated attachment rod. In particular an elongated member is a member being long and thin. For example, an elongated member has a length being a multiple of the members width or diameter. The elongated member includes a first end, which is provided as the first attachment member. Preferably, the wind vane is mounted to the first end, preferably via a first attachment flange. Furthermore, the elongated member includes a second end being opposite to the first end, said second end can be provided as the second attachment member. According to a different embodiment the second attachment member can be provided by a portion of this elongated member, said portion being located somewhere between the first end and the second end thereof. Preferably the elongated member is mounted to the nacelle, in particular to the inside of the nacelle, via said second attachment member, preferably by means of a second attachment flange. According to a preferred embodiment, the first end of the elongated member is located outside the nacelle, whilst the second end of the elongated member is located inside the nacelle.

According to the afore mentioned embodiment, the laser device is mounted to the elongated member, in particular in the vicinity of the second end or somewhere in the lower half or the lower third thereof. The elongated member can be manufactured in one piece. Nevertheless, according to an alternative embodiment, the elongated member can be provided as two or more elements which are connected to one another, preferably via respective attachment flanges. In such a case, it is preferred that the two or more elements are in line with one another. Preferably, the attachment device, in particular the elongated member, can be installed or is installed in vertical. This means that the attachment device has a vertical orientation in relation to the component, to which the attachment device is mounted via its second attachment member, to a component of the nacelle for example.

As mentioned further above the present invention is not delimited to specific types and configurations of the first calibration mark.

According to a preferred embodiment, the first calibration mark of the attachment device includes a groove, in particular one single groove. Said groove might be provided at or in the attachment device over a predefined length, over up to 30% or up to 50% or up to the total length of the attachment device, an elongated member for example. According to a preferred embodiment, the starting point of said groove is the second end of the attachment device and the groove extends in the direction of the first end of the attachment device.

According to a different alternative the first calibration mark includes two or more grooves, said grooves being separated from one another and being aligned in a row.

According to both embodiments, the laser device is mounted to the attachment device such, that the generated laser beam hits at least one groove and that the generated laser beam is aligned with the at least one groove, in particular over the whole length of the groove, which is from the beginning of the groove to the end of the groove. Preferably the laser beam generated by said laser device hits this groove, the starting point of which is the second end of the attachment device and which extends in the direction of the first end of the attachment device.

In general, a groove which can be named as a notch as well, is an elongated recess. The at least one groove is provided or formed in the attachment device, in particular in the outer surface of the attachment device.

If the laser beam or a first portion of the laser beam generated by the laser device hits the at least one groove, the laser beam runs inside the groove along the alignment of the groove such that the laser beam acts as an elongation of the groove. Since the groove which is the first calibration mark, represents or corresponds to the predefined position of the wind vane, the 0° position for example, the laser beam running along the groove represents or corresponds to the predefined position of the wind vane as well. In such a case, the predefined position of the wind vane is aligned or oriented on the groove of the attachment device, the elongated member for example, as well. In this case the laser device is mounted to the attachment means, the elongated member for example, in such a way that the laser beam or the first portion of the laser beam as described further above, and therefore the generated laser line hits the groove, preferably inside the nacelle. Therefore, the predefined position of the wind vane is transferred into the nacelle. If two or more grooves are provided, one groove, which is hit by the laser beam, is preferably provided inside the nacelle, whilst another groove, an outer groove, is provided outside the nacelle, at least partially. In such a case, the groove inside the nacelle and the groove outside the nacelle are preferably in line with each other.

As described above the laser device is preferably aligned such that the laser beam meets the groove. For this purpose, it is advantageous to provide a groove which is as long as possible. According to a preferred embedment, the first calibration mark is provided as one single continuous groove extending over the whole length or up to 50% of the length or up to 30% of the length of the attachment device, from the second end of the elongated member in the direction of the first end of the elongated member for example, In particular the laser device is mounted to the attachment device at the upper end of the groove The laser beam hitting the groove and running along the groove now displays the predefined position of the wind vane, the 0° position for example. In any case it is preferred that the laser beam hitting a groove hits this groove over its entire length that is from the beginning of the groove to the end of the groove.

If the laser device is provided as a line laser device as mentioned above, that is as a line laser device generating a fanned-out laser beam spanning an angle, the laser irradiation fanning-up to the laser line does not only hit the groove, preferably with a first portion as mentioned further above. Rather, the laser irradiation is lead or guided into the nacelle as well, preferably with a second portion as mentioned further above. Since the fanned-out laser beam, which ends in the laser line and which therefore generates a laser beam plane or a laser beam pattern, one portion of the generated laser irradiation hits the first calibration mark whilst simultaneously a second portion of the generated laser irradiation is directed away from the first calibration mark, preferably into the interior space of the nacelle. In particular the laser irradiation is lead in the direction of the front end of the nacelle, said front end being the rotor side of the nacelle. Due to such a construction, a method of calibrating a wind vane according to the third aspect of the invention can be advantageously performed.

According to yet another preferred embodiment, the second attachment member is provided such that it is adapted for detachably and/or pivotally mounting the calibration device to the wind turbine, in particular inside or outside the nacelle of the wind turbine. For example, the second attachment member, preferably via an attachment flange, preferably can be mounted to a component of the drive train, to a heat exchanger structure or to the nacelle, in particular to the nacelle roof, for example, such that a rotation of the calibration device is kept possible during the calibration procedure. A preferred embodiment for such a calibration procedure is described with respect to the third aspect of the invention further below.

Preferably, the calibration device includes a wind vane, said wind vane being mounted to the first attachment member. With regard to the wind vane, full reference is also made to the aforementioned description. Preferably the wind vane is attached or can be attached to the first attachment member via an attachment flange. In such a case, the attachment flange may include a calibration mark, a groove for example, as well, sad calibration mark of the attachment flange being aligned to the first calibration mark of the attachment device, a groove for example. In addition to the first calibration mark, this calibration mark being provided by the attachment flange represents or corresponds to the predefined position of the wind vane, the 0° position for example, as well.

According to a preferred embodiment, the wind vane includes an axis of rotation, which axis of rotation being aligned to a central axis of the attachment device, in particular to the symmetry axis of the attachment device. In this case the axis of rotation of the wind vane is fixed in line with the central axis of the attachment device, the elongated member for example.

Preferably, the wind vane includes a second calibration mark, which represents the predefined orientation of the wind vane, in particular the 0° position. This second calibration mark is aligned in accordance with the first calibration mark of the attachment device, and optionally with the calibration mark on the attachment flange, by means of which the wind vane is mounted to the first attachment member. Due to this second calibration mark which defines the predefined position of the wind vane, the 0° position for example, and which is aligned to the at least one first calibration mark, the predefined position of the wind vane is preferably transferred to the inside of the nacelle, to which the wind vane is mounted via the attachment device of the calibration device.

According to yet another preferred embodiment, the laser device is detachably or non-detachably mounted to the attachment device. The present invention is not delimited to specific types of connection. In particular, the laser device can be coupled to the attachment device through a magnetic connection, a clamp connection, a screw connection, an adhesive connection, or the like.

The calibration device according to the first aspect of the invention preferably provides a solution which allows to aligning a wind vane in relation to the orientation of the rotor, in particular to the rotational axis of the rotor, such that a predefined position of the wind vane, the 0° position or mark, the North position or mark, the South position or mark, for example is oriented in parallel to the orientation of the rotor, in particular to the alignment of the rotational axis of the rotor. As described further above the present invention is not delimited to specific predefined positions of the wind vane.

By means of the calibration device according to the first aspect the predefined position or mark of the wind vane can be or is preferably transferred to the inside or the interior of the nacelle.

The wind vane, optionally via an attachment flange, is mounted to the attachment device, an elongated member for example. The attachment device includes a first calibration mark, a groove at one or both of its end or one single continuous groove for example, said first calibration mark being aligned to the predefined position of the wind fane, to a second calibration marker representing this predefined position, which is mounted to or provided at the wind vane, for example. Therefore, the first calibration mark of the attachment device represents or corresponds to the predefined position of the wind vane.

If the first calibration mark of the attachment device is provided as a groove, the groove is preferably as long as possible. A laser device, in particular a line laser device, is mounted to the first attachment device such, that it provides a laser beam, which is capable of hitting the first calibration mark, the groove for example. Therefore, the generated laser beam represents or corresponds to the predefined position of the wind vane as well.

Preferably, the attachment device with the wind vane mounted thereto is pivotally mounted to the nacelle, in particular to the interior of the nacelle, such that the wind vane, for calibration purposes, can be repositioned by means of pivoting the attachment device, if necessary. Once the calibration procedure has been successfully completed, the attachment device can be fixed.

The laser device does not only irradiate the laser beam onto the calibration mark, into the groove for example, but also into the nacelle, such that a calibration procedure, particularly as described with regard to the third aspect of the invention, can be performed.

With regard to the construction and the function of the calibration device and its single components, full reference is also made to the description of the second aspect of the invention and of the third aspect of the invention as disclosed further below.

According to the second aspect of the invention, a wind turbine is provided, said wind turbine including a nacelle, a drive train being mounted inside said nacelle and a rotor, which is pivotally mounted around a rotational axis to the drive train, whereby the rotational axis of the rotor preferably corresponds to a reference axis or to a reference plane of the drive train, said wind turbine further including a wind vane, which is mounted to the nacelle. The wind turbine is characterized in that it includes a device for calibrating the wind vane in relation to the orientation of the rotor, said calibration device being mounted to the nacelle, in particular being lead inside the nacelle, said calibration device including an attachment device with a first attachment member, to which the wind vane is mounted, and with a second attachment member, by means of which the calibration device is mounted to the nacelle, a first calibration mark, which is mounted to or provided at the attachment device, said first calibration mark representing or corresponding to a predefined orientation of the wind vane, in particular the 0° position of the wind vane, and a laser device, which is mounted to the attachment device or which is adapted to interact with the attachment device, such that a laser beam being generated by said lased device hits the first calibration mark.

The wind turbine according to the second aspect of the invention, which is preferably a wind turbine of the horizontal type, has a basic construction, which is generally known in the state of the art. The wind turbine includes a nacelle which incorporates a drive train. The drive train transmits the rotor speed to the generator where it is converted into electric energy. Therefore, the wind turbine includes a rotor being connected to said drive train, said rotor preferably including a hub and at least one rotor blade, preferably three rotor blades. The rotor is pivotally mounted around a rotational axis to the drive train, whereby the rotational axis of the rotor preferably corresponds to the reference axis, the central axis for example, or to the reference plane, the vertical mid-plane for example, of the drive train. In particular the rotational axis is in line with the reference axis or with the reference plane of the drive train. In order to adjust the orientation of the rotor in relation to the wind direction, the wind direction is generally measured by means of a wind vane. For this purpose, the wind turbine further includes at least one wind vane, which is mounted to the nacelle, in particular to the roof of the nacelle. It is preferred, that the wind vane is mounted to the wind turbine, in particular to the nacelle, as far away as possible from the rotor, in particular in the rear portion of the nacelle which is opposite to the front portion of the nacelle, where the rotor is connected to the drive train being mounted inside the nacelle.

According to the second aspect of the invention the wind turbine further includes a calibration device according to the first aspect of the present invention. The wind vane is attached to the attachment device of the calibration device, an elongated member, for example. Preferably, the attachment device is lead or guided from the outside of the nacelle to the interior of the nacelle, through an opening in the roof of the nacelle for example. The attachment device, through its second attachment member, is preferably mounted to the nacelle, in particular as described with regard to the first aspect of the invention further above. It is preferred that the laser device of the calibration device is located and mounted inside the nacelle.

Preferably the wind turbine includes two such wind vanes, each wind vane being mounted to the wind turbine via a calibration device according to the first aspect of the invention.

With regard to the construction and the function of the wind turbine and its components, full reference is also made to the description of the first aspect of the invention as disclosed further above, as well as to the description of the third aspect of the invention as disclosed further below. In particular the wind turbine includes a calibration device according to the first aspect of the present invention, said calibration device including one or more features as described in detail further above.

According to the third aspect of the present invention a method is provided, said method being a method of calibrating a wind vane in relation to the orientation of a rotor of a wind turbine, in particular a wind turbine according to the second aspect of the invention, said wind turbine including a nacelle, a drive train being mounted inside said nacelle and a rotor, which is pivotally mounted around a rotational axis to the drive train, whereby the rotational axis of the rotor preferably corresponds to a reference axis, the central axis for example, or to a reference plane, the vertical mid-plane for example, of the drive train, said wind turbine further including a wind vane, which is mounted to the nacelle. The method according to the third aspect of the invention is characterized by the following steps:
A) Determining the orientation of the rotor, in particular determining the reference axis or the reference plane of the drive train corresponding to the rotational axis of the rotor, in particular determining the position and/or orientation thereof;
B) By means of a calibration device to which the wind vane is mounted, in particular a calibration device according to the first aspect of the present invention, said calibration device being mounted to the nacelle, in particular being lead inside the nacelle of the wind turbine, said calibration device including a laser device generating a laser beam, said laser beam hitting a first calibration mark which is provided by said calibration device, said first calibration mark corresponding to a predefined orientation of the wind vane, in particular the 0° position of the wind vane;
C) Measuring the distance between the determined orientation of the rotor, in particular between the reference axis or the reference plane of the drive train corresponding to the rotational axis of the rotor, and the laser beam generated by said laser device, at two or more different locations being spaced apart from one another;
D) By means of the measured distance values, calibrating the wind vane in relation to the orientation of the rotor.

The method according to the third aspect of the invention is performed in a wind turbine, said wind turbine including a nacelle, a drive train being mounted inside said nacelle and a rotor, which is pivotally mounted around a rotational axis to the drive train, whereby the rotational axis of the rotor preferably corresponds to the reference axis, the central axis for example, or a reference plane, the vertical mid-plane for example, of the drive train, said wind turbine further including a wind vane, which is mounted to the nacelle, in particular to the roof of the nacelle. Preferably the wind turbine is a wind turbine according to the second aspect of the invention. With regard to the construction and the function of the wind turbine and its components, full reference is also made to the description of the first aspect of the invention and to the description of the second aspect of the invention as disclosed further above.

For calibrating the wind vane of the wind turbine in relation to the orientation of the rotor of the wind turbine, the method according to the third aspect of the invention comprises the following steps A) to D).

According to the first step A), the orientation of the rotor is determined. In particular, the reference axis or the reference plane of the drive train corresponding to the rotational axis of the rotor, preferably the position and/or orientation thereof, is determined. This can be performed in different ways. For example, the reference axis or the reference plane of the drive train can be determined or marked by means of an optical determination method, by use of a laser device for example, or by means of a mechanical determination method, by use of a rope being loaded by a weight for example.

According to a next step B), which nevertheless can be performed simultaneously with step A) or prior to step A), a laser beam is generated by a laser device, said laser device being part of a calibration device, to which the wind vane is mounted. In particular the calibration device is a calibration device according to the first aspect of the present invention. With regard to the construction and the function of the calibration device and its components, full reference is also made to the description of the first aspect of the invention and to the description of the second aspect of the invention as disclosed further above. In any case, the calibration device is mounted to the nacelle. In particular the calibration device is lead or guided inside the nacelle of the wind turbine. The calibration device includes the laser device. The laser device generates a laser beam, said laser beam hitting a first calibration mark which is comprised by said calibration device, said first calibration mark corresponding to a predefined orientation of the wind vane, in particular the 0° position of the wind vane. Therefore, according to step B) the laser device of the calibration device generates a laser beam which represents or corresponds to the predefined position of the wind vane, the 0° position for example.

According to subsequent step C), the distance between the determined orientation of the rotor, in particular between the reference axis or the reference plane of the drive train corresponding to the rotational axis of the rotor, and the laser beam generated by said laser device is measured. Preferably the distance is measured such that the measured distance extends in a right angle from the reference axis or the reference plane of the drive train corresponding to the rotational axis of the rotor. According to the invention the distance is measured at two or more different locations being spaced apart from one another, each location being a measuring location. For performing the method according to the third aspect of the invention it is sufficient to measure the distance at two different measuring locations. However, according to a preferred embodiment the distance is measured at more than two measuring locations, preferably at three, four, five or more measuring locations. Furthermore, it is preferred that the distance between adjacent measuring locations is as large as possible, in order to avoid or minimize any sources of error.

Finally, according to step D), and by use of the measured distance values, the wind vane is calibrated in relation to the orientation of the rotor. In particular the wind vane is calibrated such that the wind vane is oriented or adjusted in parallel to the orientation of the rotor which preferably corresponds to the alignment and/or orientation of the reference axis or the reference plane of the drive train being located inside the nacelle, whereby the reference axis or the reference plane of the drive train preferably is in line with the rotational axis of the rotor.

The present invention is not delimited to specific types of calibration procedures. Some preferred embodiments are described in more detail further below.

According to a preferred embodiment the laser device of the calibration device includes a line laser device, said line laser device including a laser source, said laser source generating a laser beam, said line laser device being adapted such that the laser beam generated by said laser source is fanned-out to a laser line, whereby the fanned-out laser beam spans an angle, whereby a first portion of the generated laser line, which may include a first limitation side of a triangular shaped laser beam plane or beam pattern resulting in the laser line as described with regard to the first aspect of the invention further above, hits the first calibration mark and whereby a second portion of the generated laser line is coincidently irradiated inside the nacelle, whereby the second portion of the generated laser line may include a second limitation side of a triangular shaped laser beam plane or beam pattern resulting in the laser line as described with regard to the first aspect of the invention further above, whereby the distance between the determined orientation of the rotor, in particular between the reference axis or the reference plane of the drive train corresponding to the rotational axis of the rotor, and the second portion of the generated laser line or the generated laser beam plane or beam pattern resulting in the laser line and being irradiated into the nacelle, is measured at the two or more measuring locations being spaced apart from one another as mentioned further above.

In the following, different preferred embodiments of performing the calibration step D) are described in greater detail.

According to a first preferred embodiment, the calibration of the wind vane in relation to the orientation of the rotor is performed such, that based on the measured distance values the calibration device, to which the wind vane is mounted, is turned or rotated until the distance between the orientation of the rotor, in particular between the reference axis or the reference plane of the drive train corresponding to the rotational axis of the rotor and the laser beam generated by said laser device, in particular the second portion of the laser beam, is equal or even at each measuring location. According to this embodiment, by means of a double or multiple measurement of the distance between the drive train and the laser beam being expanded and continued inside the nacelle at different measuring locations, a deviation between the laser beam and the drive train which corresponds to the orientation of the rotor, can be determined. By means of the adjustable calibration device, to which the wind vane is mounted, the attachment device with the first calibration mark, which represents or corresponds to the predefined position of the wind vane, in particular the 0° position, can be turned or rotated until all measured distances are equal or even. By making the distance between the different measuring locations as large as possible, any negative effects based on measurement or reading errors can be minimized According to this embodiment it is preferred that two or more distances from the generated laser beam, in particular from the generated laser line to the reference axis or the reference plane of the drive train are measured. The attachment device of the calibration device with the wind vane mounted thereto can be turned or rotated, until the distance measurements at all measurement locations are equal or even. Afterwards the attachment device can be fixed or gets fixed in order to prevent any further rotation. Preferably a marking inside the nacelle, defining the predefined position of the wind vane, can be provided in order to check any changes for future maintenance procedures.

According to a second preferred embodiment, the calibration device is fixedly mounted to the nacelle. This means that the calibration device is not adjustable. In such a case, the calibration of the wind vane in relation to the orientation of the rotor, in particular to the reference axis or the reference plane of the drive train corresponding to the rotational axis of the rotor is performed such that the measured distance values at each measuring location are transmitted to a control device, and that the control device, in particular by means of a method of determining the angle deviation, calculates a clearing value with regard to the calibration of the wind vane. These clearing values are transmitted to the control unit of the wind turbine. According to this embodiment the attachment device of the calibration device is not adjustable such that the orientation of the predefined position of the wind vane, the 0° position for example cannot be changed. Therefore, the measurement of the different distances results in a trapezium. Upon the determination of all distances between the generated laser beam, the generated laser line in particular, and the orientation of the rotor, in particular the reference axis or reference plane of the drive train corresponding to the rotational axis of the rotor, as well as of the distances between the different measurement locations, an angle deviation can be calculated which can be directly fed into the control device.

The present invention as described according to its different aspects allows the calibration of a wind vane in an easy way. For performing the calibration procedure only a few components are required, most of which can be located or mounted inside the nacelle. According to a preferred embodiment the calibration device includes the following basic components: a wind vane or wind sensor element, a mark of the predefined position of the wind vane, of the 0° position for example, an attachment device, an elongated member for example, a first calibration mark, a groove for example, a laser device, a line laser device for example, and a laser beam, a laser line for example.

The present invention according to its three aspects has a number of advantages. First of all, any losses of earnings due to a false calibration of the wind vane can be avoided or reduced. Any additional structural loads due to a false calibration of the wind vane can be reduced. The calibration of the wind vane is transferred from the outside of the nacelle to the interior of the nacelle. This results in a reduced dwelling time on the roof of the nacelle during installation and maintenance procedures. The use of a laser device inside the nacelle is always possible, especially during bad light conditions for a laser device outside the nacelle. The installation of a calibration device according to the present invention can be achieved with a minimum of amendments to be made to existing wind turbines.

### BRIEF DESCRIPTION OF THE DRAWINGS

The invention will now be explained in more detail with respect to exemplary embodiments with reference to the enclosed drawings, wherein:

FIG. 1 is a perspective view of a wind turbine;

FIG. 2 is a side view of a calibration device according to the present invention;

FIG. 3 is a side view of the embodiment of FIG. 2 as it is mounted to the nacelle of the wind turbine;

FIG. 4 is a perspective view of a section of the calibration device as shown in FIG. 2, whereby the beam pattern of the laser beam generated by the laser device is shown in more detail, and

FIG. 5 is a schematic view of the interior of the nacelle of a wind turbine for explaining the method of calibrating the wind vane according to the present invention.

The foregoing and other aspects will become apparent from the following detailed description of the invention when considered in conjunction with the accompanying drawing figures.

### DESCRIPTION OF THE INVENTION

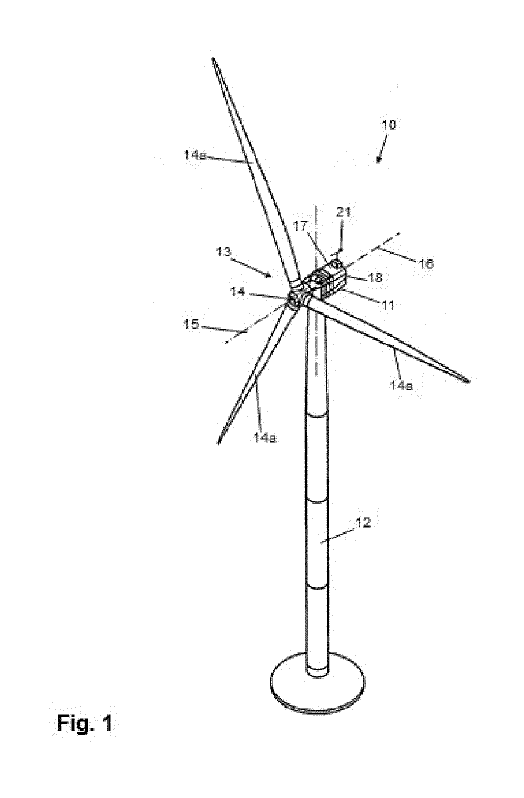

FIG. 1 shows a wind turbine (10) of the horizontal type with a tower (12) and a nacelle (11). Nacelle (11) is rotatable mounted to the tower (12). Nacelle (11) incorporates a drive train (not shown), said drive train being mounted inside nacelle (11) and being connected to a rotor (13). Rotor (13) includes three rotor blades (14a) which are mounted to a hub (14). Hub (14) of rotor (13) is connected to a drive shaft of the drive train. The rotor blades (14a) are adjustably mounted on the hub (14). This is realized by means of pitch drives, said pitch drives being part of a pitch system. The pitch system controls the rotor speed to given set points. By means of pitch-drives, the rotor blades (14a) may be moved about a rotor blade axes into different pitch positions.

The rotor (13) is rotatable connected to the drive train via its rotational axis (15). Rotational axis (15) of rotor (13) is aligned with a reference axis (16) or reference plane of the drive train which preferably is the central axis or the vertical mid-plane of the drive train.

In order to determine the wind direction, wind turbine (10) includes a wind vane (21). The wind vane (21) is mounted in the rear portion (18) of nacelle (11) to the roof (17) of nacelle (11).

In order to precisely adjust the wind vane (21) of the wind turbine (10) for a particular function, which is in particular bringing the rotor (13) of the wind turbine (10) into an advantageous orientation with regard to the wind direction, in order to improve the generation of electrical power by the wind turbine (10), the wind vane (21) is mounted to the nacelle (11) via a calibration device (20).

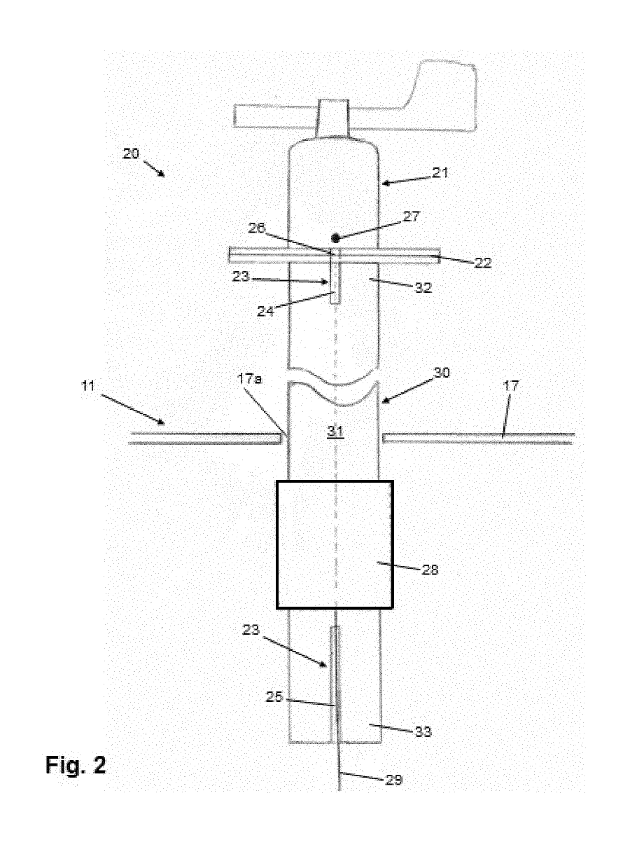

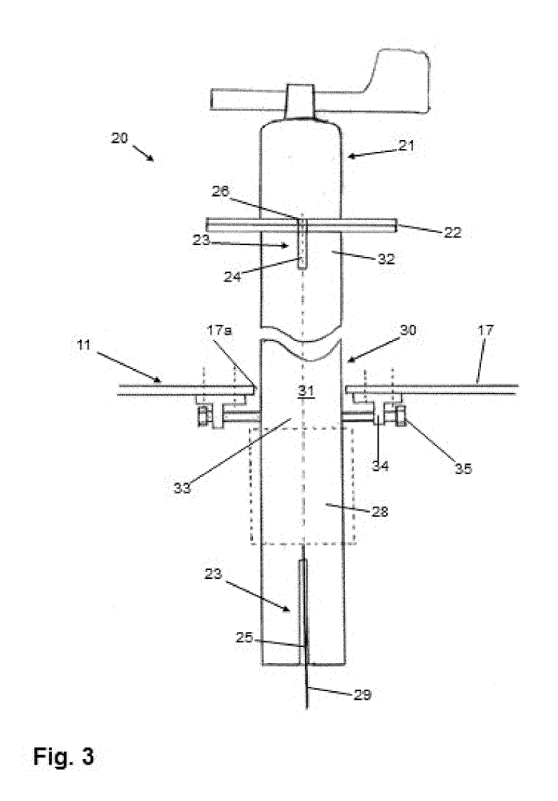

This calibration device (20) is depicted in detail in FIGS. 2 and 3. The calibration device (20) includes an attachment device (30) which is used to mount wind vane (21) to nacelle (11). Attachment device (30) is provided as an elongated attachment tube (31). Attachment device (30) includes a first attachment member (32), to which the wind vane (21) is mounted, preferably via an attachment flange (22). Attachment device (30) further includes a second attachment member (33) by means of which the calibration device (20) is mounted to the nacelle (11), in particular to the interior of nacelle (11). It is preferred that the attachment device (30) is connected via its second attachment member (33) to nacelle (11), in particular to the roof (17) of nacelle (11). Since the attachment device (30) is formed as an elongated attachment tube (31), the first attachment member (32), corresponds to the first end of attachment tube (31). For example, the second attachment member (33) may correspond to the second end of attachment tube (31) or to a portion somewhere between the first end and the second end of attachment device (30).

Wind vane (21) includes a second calibration mark (27) which represents or corresponds to a predefined orientation of the wind vane (21), to the 0° position of wind vane (21) for example.

Attachment flange (22) includes a groove (26) which acts as a calibration mark as well, whereby the second calibration mark (27) of wind vane (21) and the groove (26) are in line with each another. In similar way, attachment device (30) includes two grooves (24) and (25), which act as a first calibration mark (23) and which are in line with each another, as well as in line with the second calibration mark (27) and the groove (26). Grooves (24) and (25) are provided in the area of the first and second end of attachment device (30).

By means of these calibration marks (27), (26), (25) and (24) the predefined position of wind vane (21) is transferred from the outside of nacelle (11) to the attachment device (30) inside nacelle (11).

As evident from FIGS. 2 and 3, a first portion of attachment device (30) is located outside of roof (17) of nacelle (11), to which wind vane (21) is mounted. A second portion of attachment device (30) is located inside nacelle (11). For this purpose, roof (17) includes an opening (17a) through which the attachment device (30) is lead or guided such that the second attachment member (33) of attachment device (30) can be fixed inside nacelle (11). As evident from FIG. 3 the attachment device (30) can be fixed via its second attachment member (33) to the inside of roof (17) of nacelle (11), by means of an attachment flange (34) for example. Using screws (35) the attachment device (30) can be fixed and held in position once the calibration procedure has been completed.

Mounted to attachment device (30) is a laser device (28), a line laser device for example said laser device (28) being mounted inside nacelle (11). Laser device (28) generates a laser beam (29).

The calibration device (20) according to the invention provides a solution which allows to align the wind vane (21) in relation to the orientation of the rotor (13), in particular to the rotational axis (15) of the rotor (13) (see FIG. 1), such that a predefined position of the wind vane (21), the 0° position or mark for example, is oriented in parallel to the orientation of the rotor (13), in particular to the alignment of the rotational axis (15) of the rotor (13).

By means of the calibration device (20) the predefined position or mark of the wind vane (21) is transferred to the inside or the interior of the nacelle (11) by means of second calibration mark (27) and grooves (26), (25), (24) which are in line with one another. Therefore, the first calibration mark (23) of the attachment device (30), which is provided by grooves (24), (25), represents or corresponds to the predefined position of the wind vane (21).

The laser device (28), in particular a line laser device, which is mounted to the attachment device (30), provides laser beam (29), which is capable of hitting the first calibration mark (23), the groove (25) in the area of second attachment member (33) for example. Therefore, the generated laser beam (29) represents or corresponds to the predefined position of the wind vane as well.

Preferably, the attachment device (30) with the wind vane (21) mounted thereto is pivotally mounted to the interior of nacelle (11), such that the wind vane (21), for calibration purposes, can be repositioned by means of pivoting the attachment device (30), if necessary.

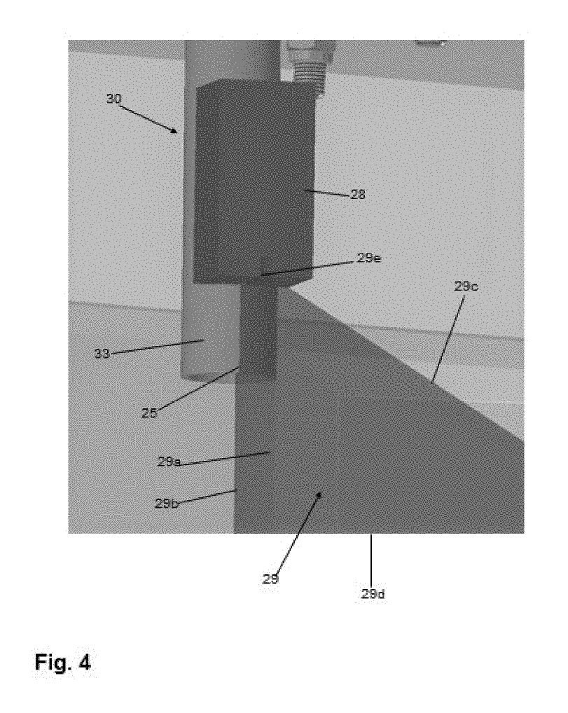

Now, in connection with FIG. 4, the generation of laser beam (29) by laser device (28) will be explained. Laser device (28) which is mounted to attachment device (30) in the area of second attachment member (33) is a line laser device. A line laser device is a laser device with a specific optics generating a laser line (29d) instead of a laser point. The line laser device includes a laser source, a punctual laser source for example. By means of optical elements, the laser beam (29) generated by said laser source is fanned-out to laser line (29d), whereby the fanned-out laser beam (29a) spans an angle. This means that the fanned-out laser beam (29a) spreads out in a plane. This plane preferably corresponds to a specific beam pattern of the generated laser light. In particular, this plane or beam pattern can have a triangular or almost triangular shape. If the laser beam which is generated by the laser source and which is fanned-out to a laser line (29d) spreads out in such a triangular shaped plane or beam pattern, the laser source and the optical elements for fanning-out the laser beam can be located in the top (29e) of the triangle. One side of the triangle being opposite to the top (29e) of the triangle represents the laser line (29d) generated by said laser source. Both sides of the triangle connecting the top (29e) of the triangle with the side of the triangle representing the generated laser line (29d) are limiting sides (29b), (29c) of the triangle. These limiting sides (29b), (29c) border the plane or beam pattern of fanned-out laser beam (29a) generated by said laser source, said laser plane ending in the laser line (29d). If the laser device (28) is provided in such a way it is preferably one of the limitation sides (29b) of the generated fanned-out triangular laser beam (29a), which hits the first calibration mark (23) of the calibration device (20), groove (25) in the present case. Due to the spanned angle, the second limitation side (29c) is directed away from the attachment device (30), in particular away from the first calibration mark (23). The second limitation side (29c) is directed into the interior of nacelle (11).

By means of laser beam (29) generated by laser device (28) the wind vane can be calibrated in relation to the orientation of the rotor of the wind turbine.

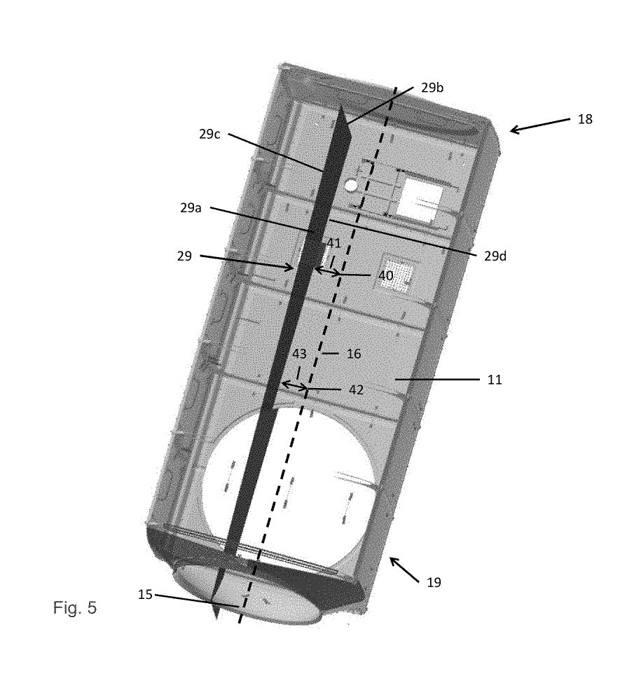

This calibration method will now be explained in detail by making reference to FIG. 5. FIG. 5 depicts a schematic view of the interior of nacelle (11) whereby the wind vane is mounted via the calibration device to the nacelle in the rear portion (18) thereof. The rotor of the wind turbine is connected to the drive train at the opposite end of nacelle (11) which is the front portion (19) thereof.

In a first step, the orientation of the rotor is determined. This is achieved by determining a reference axis (16) or reference plane of the drive train which preferably is the central axis (16) or the vertical mid-plane of the drive train, whereby these components correspond to the rotational axis (15) of the rotor, since all of these components are in line with each other. In particular the orientation or the position of the reference axis (16) or reference plane of the drive train is determined. The determination can be performed by means of an optical or mechanical determination procedure.

Next, by means of the laser device of the calibration device, the laser beam (29) is generated according to the representation in FIG. 3 and the aforementioned description thereof. This laser beam (29) corresponds to and represents the predefined orientation of the wind vane.

Next, the distance between the determined orientation of the rotor, in particular between the reference axis (16) or the reference plane of the drive train corresponding to the rotational axis (15) of the rotor, and the laser beam (29) corresponding to the predefined orientation of the wind vane, generated by said laser device, is measured at two or more different measuring locations (40), (42) being spaced apart from each another.

By means of the measured distance values (41), (43), the wind vane is calibrated in relation to the orientation of the rotor. According to a preferred embodiment, the calibration of the wind vane in relation to the orientation of the rotor is performed such, that based on the measured distance values (41), (43) the calibration device, to which the wind vane is mounted, is turned or rotated until the measured distance values (41), (43) representing the distance between the orientation of the rotor, in particular between the reference axis (16) or the reference plane of the drive train corresponding to the rotational axis (15) of the rotor and the laser beam (29) generated by said laser device, are equal or even at each measuring location (40), (42). According to this embodiment, by means of a double or multiple measurement of the distance values (41), (43) between the drive train and the laser beam (29) being expanded and continued inside the nacelle (11) at different measuring locations (40), (42), a deviation between the laser beam (29) and the reference axis (16) or the reference plane which corresponds to the orientation of the rotor, can be determined. By means of the adjustable calibration device, to which the wind vane is mounted, the attachment device with the first calibration mark, which represents or corresponds to the predefined position of the wind vane, in particular the 0° position, can be turned or rotated until all measured distances values (41), (43) are equal or even.

### LIST OF REFERENCE NUMERALS

10 Wind turbine

11 Nacelle

12 Tower

13 Rotor

14 Hub

14a Rotor blade

15 Rotational Axis of the rotor

16 Reference Axis (central axis) or reference plane (vertical mid-plane) of the drive train

17 Roof of nacelle

17a Opening in the roof

18 Rear portion of the nacelle

19 Front portion of the nacelle

20 Calibration device

21 Wind vane

22 Attachment flange

23 First calibration mark

24 Groove

25 Groove

26 Groove

27 Second calibration mark

28 Laser device

29 Laser beam

29a Fanned-out laser beam

29b Limitation side

29c Limitation side

29d Laser line

29e Top of triangle

30 Attachment device

31 Attachment tube

32 First attachment member

33 Second attachment member

34 Attachment flange

35 Screw

40 First measuring location

41 First measured distance value

42 Second measuring location

43 Second measured distance value

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A calibration device for calibrating a wind vane in relation to an orientation of a rotor of a wind turbine, comprising an attachment device comprising a first attachment member, which is adapted for receiving a wind vane; a second attachment member, which is adapted for mounting the calibration device to the nacelle of the wind turbine;
a first calibration mark, which is mounted to or provided at the attachment device, said first calibration mark representing or corresponding to a predefined orientation of the wind vane; and a laser device, which is mounted to the attachment device, such that a laser beam being generated by said laser device hits the first calibration mark.

2. The calibration device for calibrating a wind vane according to claim 1, wherein the laser device is a line laser device.

3. The calibration device for calibrating a wind vane according to claim 2, wherein the line laser device comprises a laser source, said laser source generating a laser beam, wherein the line laser device is adapted such that the laser beam generated by said laser source is fanned-out to a laser line, whereby the fanned-out laser beam spans an angle.

4. The calibration device for calibrating a wind vane according to claim 1, wherein the attachment device is provided as an elongated member, said elongated member comprising a first end, which is provided as the first attachment member.

5. The calibration device for calibrating a wind vane according to claim 1, wherein the first calibration mark of the attachment device comprises at least one groove, and the laser device is mounted to the attachment device such that the generated laser beam hits the at least one groove and that the generated laser beam is aligned with the at least one groove.

6. The calibration device for calibrating a wind vane according to claim 1, wherein the second attachment member is provided such that the second attachment member is adapted for detachably and/or pivotally mounting the calibration device to the wind turbine.

7. The calibration device for calibrating a wind vane according to claim 1, wherein the calibration device comprises a wind vane, said wind vane being mounted to the first attachment member.

8. The calibration device for calibrating a wind vane according to claim 7, wherein the wind vane comprises an axis of rotation and the axis of rotation is aligned to a central axis of the attachment device.

9. The calibration device for calibrating a wind vane according to claim 7, wherein the wind vane comprises a second calibration mark, which represents the predefined orientation of the wind vane, and the second calibration mark is aligned in accordance with the first calibration mark of the attachment device.

10. The calibration device for calibrating a wind vane according to claim 1, wherein the laser device is detachably or non-detachably mounted to the attachment device.

11. A wind turbine, said wind turbine comprising a nacelle; a drive train being mounted inside said nacelle; a rotor, which is pivotally mounted around a rotational axis to the drive train, whereby the rotational axis of the rotor corresponds to a reference axis or to a reference plane of the drive train; a wind vane, which is mounted to the nacelle; and a calibration device for calibrating the wind vane in relation to the orientation of the rotor, said calibration device being mounted to the nacelle, said calibration device comprising an attachment device with a first attachment member, to which the wind vane is mounted; a second attachment member, by which the calibration device is mounted to the nacelle; a first calibration mark, which is mounted to or provided at the attachment device, said first calibration mark representing or corresponding to a predefined orientation of the wind vane; and a laser device, which is mounted to the attachment device or which is adapted to interact with the attachment device, such that a laser beam being generated by said laser device hits the first calibration mark.

12. The wind turbine according to claim 11, wherein the calibration device is arranged according to claim 2.

13. A method of calibrating a wind vane in relation to an orientation of a rotor of a wind turbine according to claim 11, said wind turbine comprising a nacelle, a drive train being mounted inside said nacelle and a rotor, which is pivotally mounted around a rotational axis to the drive train, whereby a rotational axis of the rotor corresponds to a reference axis or a reference-plane of the drive train, said wind turbine further comprising a wind vane, which is mounted to the nacelle, said method comprising the following steps:
A) determining the orientation of the rotor by determining the reference axis or the reference plane of the drive train corresponding to the rotational axis of the rotor,
B) providing a calibration device according to claim 1 to which the wind vane is mounted, said calibration device comprising a laser device generating a laser beam, said laser beam hitting a first calibration mark which is provided by said calibration device, said first calibration mark corresponding to a predefined orientation of the wind vane,
C) measuring a distance between the determined orientation of the rotor, and the laser beam generated by said laser device, at two or more different locations being spaced apart from one another, and
D) by means of the measured distance values, calibrating the wind vane in relation to the orientation of the rotor.

14. The method according to claim 13, wherein the laser device comprises a line laser device, said line laser device comprising a laser source, said laser source generating a laser beam, said line laser device being adapted such that the laser beam generated by said laser source is fanned-out to a laser line, whereby the fanned-out laser beam spans an angle, whereby a first portion of the generated laser line hits the first calibration mark and whereby a second portion of the generated laser line is coincidently irradiated inside the nacelle, whereby the distance between the determined orientation of the rotor and the second portion of the generated laser line is measured at the two or more locations being spaced apart from one another.

15. The method according to claim 13, wherein the calibration of the wind vane in relation to the orientation of the rotor is performed such that based on the measured distance values the calibration device, to which the wind vane is mounted, is turned until the distance between the orientation of the rotor, the laser beam generated by said laser device, is equal at each measuring location, or that the calibration device is fixedly mounted to the nacelle and that the calibration of the wind vane in relation to the orientation of the rotor is performed such that the measured distance values at each measuring location are transmitted to a control device, and that the control device calculates a clearing value with regard to the calibration of the wind vane.
